(19) United States
(12) Patent Application Publication
(10) Pub. No.: US 2026/0213605 A1
(43) Pub. Date: Jul. 23, 2026

(54) TRACTION MACHINE AND TRACTION MACHINE SYSTEM APPLYING THE SAME

(71) Applicant: ZHONGSHAN BROAD-OCEAN MOTOR CO., LTD., Zhongshan (CN)

(72) Inventors: Liming BING, Zhongshan (CN); Yi PAN, Zhongshan (CN); Guangsheng HUANG, Zhongshan (CN)

(21) Appl. No.: 19/572,141

(22) Filed: Mar. 19, 2026

(30) Foreign Application Priority Data
Jan. 21, 2025 (CN) 2025201433973

(51) Int. Cl. H02K 5/20; B66B 1/36; B66B 11/04; H02K 7/102; H02K 7/116; H02K 9/193; H02K 11/33; H02K 21/14; H02K 24/00

(52) U.S. Cl. CPC H02K 5/203; B66B 1/36; B66B 11/043; H02K 7/102; H02K 7/116; H02K 9/193; H02K 11/33; H02K 21/14; H02K 24/00; H02K 2211/03

(57) ABSTRACT

Disclosed are a traction machine and a traction machine system applying the same. The traction machine comprises a permanent magnet synchronous motor, a brake, a reduction gearbox and a traction sheave, wherein a motor shaft of the motor is mechanically connected to an input shaft end of the reduction gearbox, the brake acts on the input shaft end of the reduction gearbox, and an output shaft end of the reduction gearbox is connected to the traction sheave, wherein the traction machine further comprises a motor controller, which is mounted at one end of the permanent magnet synchronous motor, a first water cooling channel is disposed in a housing of the motor controller, a second water cooling channel is disposed in a casing of the permanent magnet synchronous motor, and the first water cooling channel is in communication with the second water cooling channel.

### RELATED APPLICATIONS

This application claims priority to Chinese Patent Application Ser. No. 2025201433973, filed Jan. 21, 2025, the disclosure of which is hereby incorporated by reference in its entirety.

### TECHNICAL FIELD

The present application relates to a traction machine and a traction machine system applying the same.

### BACKGROUND

A traction machine is a power component in an elevator system and is responsible for driving an elevator car to lift and lower. With the development of high-rise buildings, high requirements have been put forward for the continuous operating time of elevators. A commonly used elevator traction machine is an outer-rotor permanent magnet synchronous gearless traction machine, the motor of which adopts a natural cooling mode. During the elevator operation, the problem of slow heat dissipation in the natural cooling mode may occur, leading to thermal protection shutdown of the traction machine and a poor experience that the elevator cannot be used. In addition, the outer-rotor permanent magnet gearless motor has a large outer diameter, leading to a heavy overall weight of the traction machine and cumbersome installation, and a heavy-load hoisting device is therefore required for the installation. Moreover, the controller of the traction machine is a naturally cooled type, which is large in volume, heavy in weight and inconvenient to install.

### SUMMARY

The present application provides a traction machine and a traction machine system applying the same, so as to solve the problem of poor heat dissipation effect of the traction machine in the prior art.

The technical solution of the present application is realized as follows:

A first object of the present application is to provide a traction machine, comprising a permanent magnet synchronous motor, a brake, a reduction gearbox and a traction sheave, wherein a motor shaft of the motor is mechanically connected to an input shaft end of the reduction gearbox, the brake acts on the input shaft end of the reduction gearbox, and an output shaft end of the reduction gearbox is connected to the traction sheave, wherein the traction machine further comprises a motor controller, which is mounted at one end of the permanent magnet synchronous motor, a first water cooling channel is disposed in a housing of the motor controller, a second water cooling channel is disposed in a casing of the permanent magnet synchronous motor, and the first water cooling channel is in communication with the second water cooling channel.

A friction plate of the brake acts on the input shaft end of the reduction gearbox via a brake shaft sleeve.

A brake mounting bracket is disposed along an axial direction on the casing of the permanent magnet synchronous motor, and the brake is mounted on the brake mounting bracket.

A control board and a resolver are disposed in the motor controller, the resolver comprises a rotor, a stator and a stator fixing cover, the stator is mounted on the housing of the motor controller, the stator fixing cover covers the stator, and the rotor is connected to the motor shaft of the permanent magnet synchronous motor.

A wire outlet hole is provided in the stator fixing cover, and a signal wire of the resolver extends through the wire outlet hole to be connected to the control board.

A shaft diameter of an output shaft of the permanent magnet synchronous motor is smaller than a shaft diameter of the input shaft end of the reduction gearbox, and the brake shaft sleeve is mounted on the input shaft end of the reduction gearbox.

Alternatively, a shaft diameter of an output shaft of the permanent magnet synchronous motor is larger than a shaft diameter of the input shaft end of the reduction gearbox, and the brake shaft sleeve is mounted on the output shaft of the permanent magnet synchronous motor.

A second object of the present application is to provide a traction machine system, comprising a traction machine, wherein the traction machine system further comprises a water pump, a water tank and a radiator, the traction machine is the aforesaid traction machine, a water outlet of the water pump is connected to a pipeline interface of the first water cooling channel, one end of the water tank is connected to a water inlet of the water pump, the other end of the water tank is connected to one end of the radiator, and the other end of the radiator is connected to a pipeline interface of the second water cooling channel.

Compared with the prior art, the present application has the following advantages:
1. The traction machine comprises a permanent magnet synchronous motor, a brake, a reduction gearbox and a traction sheave, wherein a motor shaft of the motor is mechanically connected to an input shaft end of the reduction gearbox, the brake acts on the input shaft end of the reduction gearbox, and an output shaft end of the reduction gearbox is connected to the traction sheave, wherein the traction machine further comprises a motor controller, which is mounted at one end of the permanent magnet synchronous motor, a first water cooling channel is disposed in a housing of the motor controller, a second water cooling channel is disposed in a casing of the permanent magnet synchronous motor, and the first water cooling channel is in communication with the second water cooling channel. The traction machine not only integrates the motor controller, but also is additionally provided with water cooling channels in the motor controller and the permanent magnet synchronous motor, and liquid is adopted for rapid cooling, which is conducive to the miniaturization design of the controller, and the controller has the advantages of small volume, good cooling effect and convenient installation.
2. Other advantages of the present application will be described in detail in embodiments.

### BRIEF DESCRIPTION OF THE DRAWINGS

FIG. 1 is a structural schematic diagram of a traction machine provided in Embodiment 1 of the present application;

FIG. 2 is a sectional view of the traction machine provided in Embodiment 1 of the present application;

FIG. 3 is an enlarged view of part A in FIG. 2;

FIG. 4 is a structural schematic diagram of a traction machine provided in Embodiment 2 of the present application; and

FIG. 5 is a structural schematic diagram of a traction machine system provided in Embodiment 3 of the present application.

### DETAILED DESCRIPTION OF THE EMBODIMENTS

In order to make the purposes, technical solutions and advantages of the embodiments of the present application clearer, the technical solutions in the embodiments of the present application will be clearly and completely described below in conjunction with the accompanying drawings in the embodiments of the present application. Obviously, the described embodiments are part of the embodiments of the present application, rather than all the embodiments. Based on the embodiments in the present application, all other embodiments obtained by those skilled in the art without expenditure of creative efforts shall fall within the protection scope of the present application.

### Embodiment 1

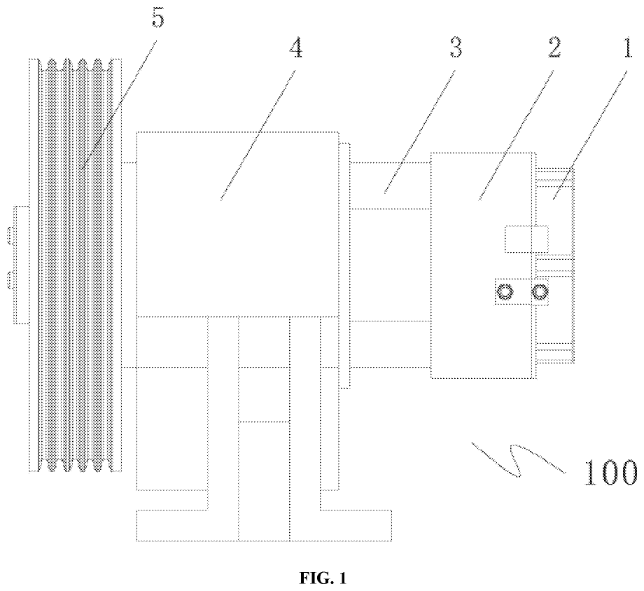

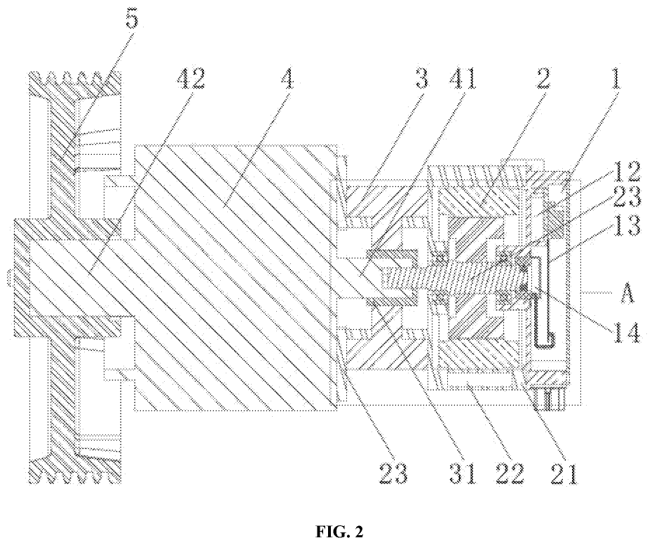

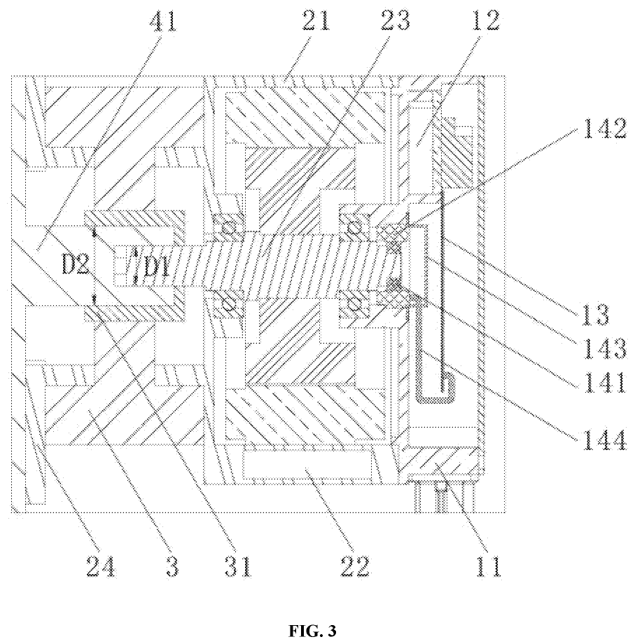

As shown in FIGS. 1 to 3, the traction machine provided in the present embodiment includes a permanent magnet synchronous motor 2, a brake 3, a reduction gearbox 4 and a traction sheave 5, wherein a motor shaft 23 of the motor 2 is mechanically connected to an input shaft end 41 of the reduction gearbox 4, the brake 3 acts on the input shaft end 41 of the reduction gearbox 4, and an output shaft end 42 of the reduction gearbox 4 is connected to the traction sheave 5. The traction machine further includes a motor controller 1, the motor controller 1 is mounted at one end of the permanent magnet synchronous motor 2, a first water cooling channel 12 is disposed in a housing 11 of the motor controller 1, a second water cooling channel 22 is disposed in a casing 21 of the permanent magnet synchronous motor 2, and the first water cooling channel 12 is in communication with the second water cooling channel 22.

The traction machine not only integrates the motor controller 1, but also is additionally provided with water cooling channels in the motor controller 1 and the permanent magnet synchronous motor 2, and liquid is adopted for rapid cooling, which is conducive to the miniaturization design of the controller, and the controller has the advantages of small volume, good cooling effect, stable operation of the traction machine and convenient installation. The first water cooling channel 12 is in communication with the second water cooling channel 22, and cooling liquid can flow in from any flow channel to complete the cooling of the motor and the controller.

The friction plate of the brake 3 acts on the input shaft end 41 of the reduction gearbox 4 via a brake shaft sleeve 31.

A brake mounting bracket 24 is disposed along an axial direction on the casing 21 of the permanent magnet synchronous motor 2, and the brake 3 is mounted on the brake mounting bracket 24.

A control board 13 and a resolver 14 are disposed in the motor controller 1, the resolver 14 includes a rotor 141, a stator 142 and a stator fixing cover 143, the stator 142 is mounted on the housing 11 of the motor controller 1, the stator fixing cover 143 covers the stator 142, and the rotor 141 is connected to the motor shaft 23 of the permanent magnet synchronous motor 2. By replacing a position sensor encoder with the resolver 14, the cost of the sensor is reduced, the control precision is not reduced, and the resolver has good environmental adaptability, which is conducive to long-term stable operation.

A wire outlet hole 144 is provided in the stator fixing cover 143, and a signal wire 145 of the resolver 14 extends through the wire outlet hole 144 to be connected to the control board 13. The signal wire 145 is directly electrically connected to the control board 13, so that the signal transmission effect is good and the cost is saved.

A shaft diameter D1 of an output shaft of the permanent magnet synchronous motor 2 is smaller than a shaft diameter D2 of the input shaft end 41 of the reduction gearbox 4, and the brake shaft sleeve 31 is mounted on the input shaft end 41 of the reduction gearbox 4. The braking moment of the brake 3 acts on the brake shaft sleeve 31, so that the traction sheave 6 can be stopped from rotating.

### Embodiment 2

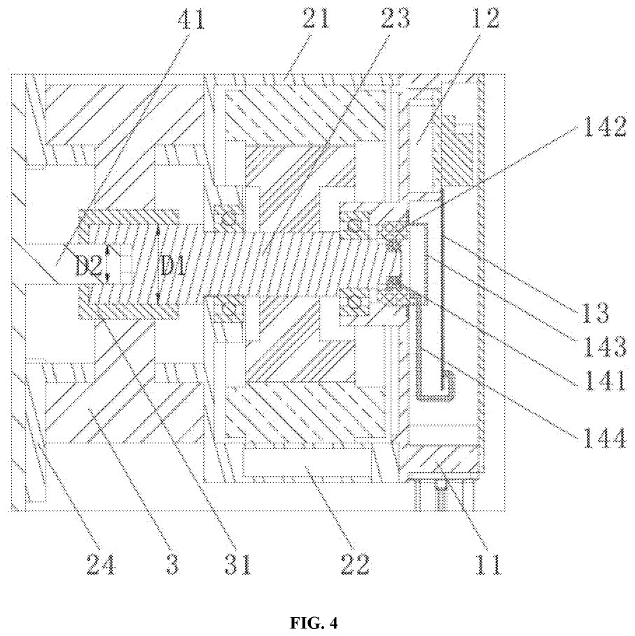

As shown in FIG. 4, the traction machine provided in the present embodiment is similar to the traction machine described in Embodiment 1, and the difference between them lies in that:

A shaft diameter D1 of an output shaft of the permanent magnet synchronous motor 2 is larger than a shaft diameter D2 of the input shaft end 41 of the reduction gearbox 4, and the brake shaft sleeve 31 is mounted on the output shaft of the permanent magnet synchronous motor 2. When the braking moment of the brake 3 acts on the brake shaft sleeve 31, the traction sheave 6 can be stopped from rotating.

### Embodiment 3

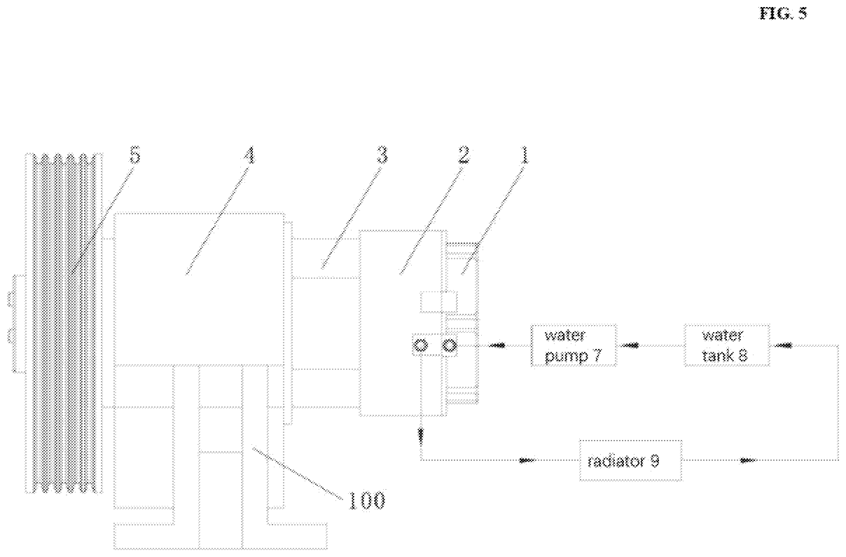

As shown in FIG. 5, a traction machine system provided in the present embodiment includes a traction machine 100, wherein the traction machine system further includes a water pump 7, a water tank 8 and a radiator 9, the traction machine 100 is the traction machine described in Embodiment 1 or Embodiment 2, a water outlet of the water pump 7 is connected to a pipeline interface of the first water cooling channel 12, one end of the water tank 8 is connected to a water inlet of the water pump 7, the other end of the water tank 8 is connected to one end of the radiator 9, and the other end of the radiator 9 is connected to a pipeline interface of the second water cooling channel 22.

Heat generated by the operation of the motor and the controller is first transferred to a liquid cooling medium via a heat dissipation system, the liquid cooling medium is heated up, and then is transferred to the radiator via the water pump and pipelines, the radiator dissipates the heat of the cooling medium in the pipelines, the cooled liquid cooling medium flows out of the radiator and flows into the flow channels of the controller and the motor via the pipelines, and the process is repeated. All pipelines are connected by hoses, which is convenient for arrangement. The cooling liquid medium is deionized water and antifreeze, which meets the requirement that the cooling liquid does not freeze under different temperature environments.

Finally, it should be noted that the above embodiments are only used to illustrate technical solutions of the present application, but not to limit it. Although the present application has been described in detail with reference to the foregoing embodiments, those skilled in the art should understand that the technical solutions recorded in the foregoing embodiments can still be modified, or some technical features thereof can be equivalently replaced. And these modifications or replacements do not make the essence of the corresponding technical solutions deviate from the spirit and scope of the technical solutions of the various embodiments of the present application.

What is claimed is:

1. A traction machine, comprising a permanent magnet synchronous motor (2), a brake (3), a reduction gearbox (4) and a traction sheave (5), wherein a motor shaft (23) of the permanent magnet synchronous motor (2) is mechanically connected to an input shaft end (41) of the reduction gearbox (4), the brake (3) acts on the input shaft end (41) of the reduction gearbox (4), and an output shaft end (42) of the reduction gearbox (4) is connected to the traction sheave (5), wherein the traction machine further comprises a motor controller (1) mounted at one end of the permanent magnet synchronous motor (2), a first water cooling channel (12) is disposed in a housing (11) of the motor controller (1), a second water cooling channel (22) is disposed in a casing (21) of the permanent magnet synchronous motor (2), and the first water cooling channel (12) is in communication with the second water cooling channel (22).

2. The traction machine according to claim 1, wherein a friction plate of the brake (3) acts on the input shaft end (41) of the reduction gearbox (4) via a brake shaft sleeve (31).

3. The traction machine according to claim 2, wherein a brake mounting bracket (24) is disposed along an axial direction on the casing (21) of the permanent magnet synchronous motor (2), and the brake (3) is mounted on the brake mounting bracket (24).

4. The traction machine according to claim 3, wherein a control board (13) and a resolver (14) are disposed in the motor controller (1), the resolver (14) comprises a rotor (141), a stator (142) and a stator fixing cover (143), the stator (142) is mounted on the housing (11) of the motor controller (1), the stator fixing cover (143) covers the stator (142), and the rotor (141) is connected to the motor shaft (23) of the permanent magnet synchronous motor (2).

5. The traction machine according to claim 4, wherein a wire outlet hole (144) is provided in the stator fixing cover (143), and a signal wire (145) of the resolver (14) extends through the wire outlet hole (144) to be connected to the control board (13).

6. The traction machine according to claim 1, wherein a shaft diameter D1 of an output shaft of the permanent magnet synchronous motor (2) is smaller than a shaft diameter D2 of the input shaft end (41) of the reduction gearbox (4), and the brake shaft sleeve (31) is mounted on the input shaft end (41) of the reduction gearbox (4).

7. The traction machine according to claim 1, wherein a shaft diameter D1 of an output shaft of the permanent magnet synchronous motor (2) is larger than a shaft diameter D2 of the input shaft end (41) of the reduction gearbox (4), and the brake shaft sleeve (31) is mounted on the output shaft of the permanent magnet synchronous motor (2).

8. A traction machine system, comprising a traction machine (100), wherein the traction machine system further comprises a water pump (7), a water tank (8) and a radiator (9), the traction machine (100) is the traction machine according to claim 1, a water outlet of the water pump (7) is connected to a pipeline interface of the first water cooling channel (12), one end of the water tank (8) is connected to a water inlet of the water pump (7), the other end of the water tank (8) is connected to one end of the radiator (9), and the other end of the radiator (9) is connected to a pipeline interface of the second water cooling channel (22).
